(19) United States
(12) Patent Application Publication
(10) Pub. No.: US 2024/0266961 A1
(43) Pub. Date: Aug. 8, 2024

(54) POWER CONVERTER

(71) Applicant: Mitsubishi Electric Corporation, Tokyo (JP)

(72) Inventors: Atsushi MATSUDA, Chiyoda-ku, Tokyo (JP); Satoshi OJIKA, Chiyoda-ku, Tokyo (JP); Tomokazu SAKASHITA, Chiyoda-ku, Tokyo (JP); Shinichiro OIKAWA, Chiyoda-ku, Tokyo (JP)

(73) Assignee: Mitsubishi Electric Corporation, Tokyo (JP)

(21) Appl. No.: 18/567,505

(22) PCT Filed: Jul. 14, 2021
(86) PCT No.: PCT/JP2021/026408

§ 371 Date: Dec. 6, 2023

(51) Int. Cl. H02M 3/158; H02M 1/00; H02M 1/44

(52) U.S. Cl. CPC H02M 3/1586; H02M 1/0009; H02M 1/44

(57) ABSTRACT

A first reactor current that flows in a first reactor and a second reactor current that flows in a second reactor are controlled by ON/OFF control over a first switching element and a second switching element. The control unit calculates a first operation amount and a second operation amount based on the first and second reactor currents detected by current detectors. The first operation amount defines an ON period of the first switching element. The second operation amount defines an ON period of the second switching element. The first and second operation amounts are calculated with non-interference control for suppressing mutual interference between the first and second reactor currents caused by magnetic coupling between the first reactor and the second reactor.

### TECHNICAL FIELD

The present disclosure relates to a power converter.

### BACKGROUND ART

As an aspect of a power converter suitable for decreases in size and weight, an interleaved converter has been known in which a plurality of DC/DC converters connected in parallel is used. The plurality of respective DC/DC converters is subjected to control to switch in different phases in the interleaved converter to make it possible to reduce a current ripple in an output capacitor. This allows the output capacitor to be decreased in size.

Japanese Patent Laying-Open No. 2012-210145 (PTL 1) describes a circuit configuration in which a magnetic coupling transformer in which 2-phase inductors are aggregated in a single core is used in a 2-phase interleaved boost converter in which two boost chopper circuits (DC/DC converters) are connected in parallel. This makes it possible to achieve further decreases in size and weight.

Further, PTL 1 describes means of correcting a current imbalance between phases caused by an element variation or the like in the 2-phase interleaved boost converter in which the magnetic coupling transformer is used. As a result, it is possible to prevent the magnetic saturation of the magnetic coupling transformer.

### CITATION LIST

### Patent Literature

PTL 1: Japanese Patent Laying-Open No. 2012-210145

### SUMMARY OF INVENTION

### Technical Problem

The use of a magnetic coupling transformer or the like for decreases in size and weight, however, has a concern about the occurrence of mutual interference between reactor currents in respective phases. A control operation in one of phases that causes such mutual interference influences an operation in the other phase.

Therefore, in the case of control design with a transfer function of a normal interleaved converter, it is not possible to obtain desired frequency characteristics in some cases. As a result, there is a concern about a problem such as degenerated responsiveness or difficulty in securing a stable operation of the whole of the interleaved converter. PTL 1, however, mentions nothing about a problem about the mutual interference between the reactor currents caused by the magnetic coupling.

The present disclosure has been devised to solve such a problem. An object of the present disclosure is to increase the responsiveness and the stability of an interleaved power converter including first and second reactors that are magnetically coupled.

### Solution to Problem

According to an aspect of the present disclosure, there is provided a power converter. The power converter includes a DC voltage conversion circuit and a control unit. The DC voltage conversion circuit converts a DC voltage between a first terminal and a second terminal. The DC voltage conversion circuit includes a first reactor, a second reactor that has inductance equivalent to that of the first reactor, a third reactor, a first semiconductor element, a second semiconductor element, a third semiconductor element, a fourth semiconductor element, and a current detector. The first reactor is connected between a first node and an intermediate node. The second reactor is connected between a second node and the intermediate node and magnetically coupled to the first reactor in reverse polarity. The third reactor is connected between an input node and the intermediate node. The input node is connected to the first terminal. The first semiconductor element is connected between a reference voltage node and the first node. The second semiconductor element is connected between the reference voltage node and the second node. The third semiconductor element is connected between the first node and the second terminal. The fourth semiconductor element is connected between the second node and the second terminal. The current detector detects a first reactor current and a second reactor current. The first reactor current flows to the first reactor. The second reactor current flows to the second reactor. One of the first and third semiconductor elements includes a first switching element and one of the second and fourth semiconductor elements includes a second switching element. The control unit performs control to turn on and off the first and second switching elements to provide a phase difference between turn-on timings of the first and second switching elements. The control unit includes a current controller. The current controller calculates a first operation amount and a second operation amount based on the first and second reactor currents detected by the current detector. The first operation amount defines an ON period of the first switching element. The second operation amount defines an ON period of the second switching element. The current controller is further configured to calculate the first and second operation amounts with non-interference control for suppressing mutual interference between the first and second reactor currents. The mutual interference is caused by magnetic coupling between the first and second reactors.

### Advantageous Effects of Invention

According to the present disclosure, the introduction of non-interference control makes it possible to increase the responsiveness and the stability of an interleaved power converter including first and second reactors that are magnetically coupled.

The non-interference control cancels mutual interference between reactor currents caused by the magnetic coupling.

### BRIEF DESCRIPTION OF DRAWINGS

FIG. 1 is a circuit diagram describing a configuration of a power converter according to a first embodiment.

FIG. 2 is a block diagram describing a hardware configuration example of a control unit illustrated in FIG. 1.

FIG. 3 is a current control block diagram of a DC voltage conversion circuit by the control unit.

FIG. 4 is a waveform chart describing an interleaving operation of the power converter according to the first embodiment.

FIG. 5 is an equivalent circuit diagram of the DC voltage conversion circuit for analyzing a relationship between a duty ratio and a reactor current.

FIG. 6 is a first waveform chart describing an operation example of non-interference control in the power converter according to the first embodiment.

FIG. 7 is a second waveform chart describing an operation example of the non-interference control in the power converter according to the first embodiment.

FIG. 8 is a third waveform chart describing an operation example of the non-interference control in the power converter according to the first embodiment.

FIG. 9 is a fourth waveform chart describing an operation example of the non-interference control in the power converter according to the first embodiment.

FIG. 10 is a circuit diagram describing a configuration of a power converter according to a second embodiment.

FIG. 11 is a waveform chart describing an interleaving operation of the power converter according to the second embodiment.

### DESCRIPTION OF EMBODIMENTS

With reference to the drawings, the following describes embodiments of the present disclosure in detail. It is to be noted that the same or corresponding portions in the drawings will be denoted by the same reference numerals below, but will not be repeatedly described in principle.

### First Embodiment

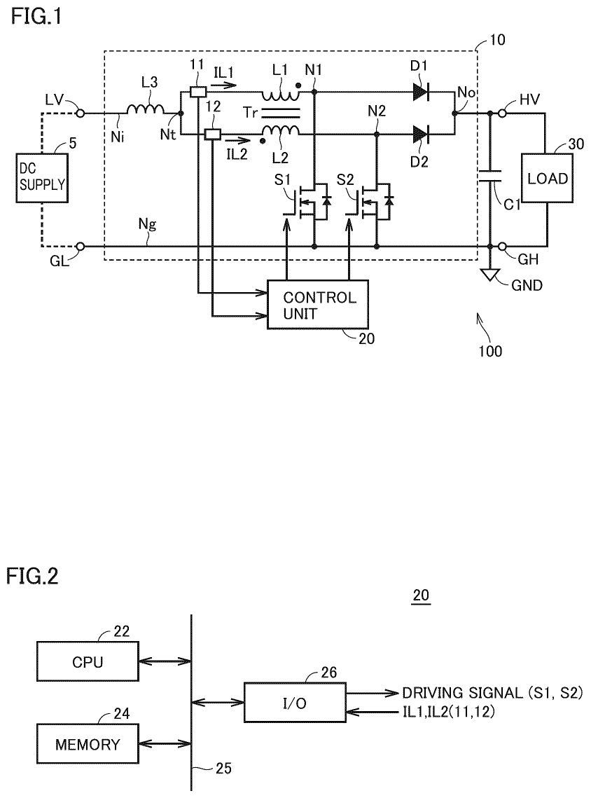

FIG. 1 illustrates a circuit diagram describing a configuration of a power converter according to a first embodiment.

As illustrated in FIG. 1, a power converter 100 according to the first embodiment includes a DC voltage conversion circuit 10, a control unit 20, a low-voltage-side terminal LV, and a high-voltage-side terminal HV.

A DC supply 5 is connected between low-voltage-side terminal LV and a grounding terminal GL. A load 30 that operates on DC power is connected to high-voltage-side terminal HV and a grounding terminal GH. A capacitor C1 is further connected in parallel with load 30 between high-voltage-side terminal HV and grounding terminal GH to smooth a DC voltage that is supplied to load 30.

For example, power converter 100 is manufactured to be mounted on an artificial satellite, which is required to be decreased in size and weight in many cases. In this case, load 30 includes devices mounted on the artificial satellite such as a communication device, an attitude control device, a propulsion device, and an observation device. In addition, it is possible to include a battery in DC supply 5. The battery is rechargeable through solar photovoltaic power generation. Grounding terminals GL and GH are connected to a reference voltage node Ng that supplies a ground voltage GND.

DC voltage conversion circuit 10 executes DC voltage conversion (DC/DC conversion) between low-voltage-side terminal LV and high-voltage-side terminal HV. DC voltage conversion circuit 10 includes reactors L1 and L2, a smoothing reactor L3, semiconductor elements S1 and S2, and semiconductor elements D1 and D2. Reactors L1 and L2 are magnetically coupled. The following also describes the inductance values of reactors L1 to L3 as L1 to L3. It is possible to include a magnetic coupling transformer Tr in reactors L1 and L2 as in PTL 1.

Reactor L3 is connected between an input node N1 and a node Nt. Input node Ni is connected to low-voltage-side terminal LV. Reactor L1 includes a first winding of magnetic coupling transformer Tr connected between node Nt and a node N1. Similarly, reactor L2 includes a second winding of magnetic coupling transformer Tr connected between node Nt and a node N2.

Magnetic coupling transformer Tr is configured by winding the first winding and the second winding described above around the same magnetic core. The first winding and the second winding are designed to have a turns ratio of 1:1 and reactors L1 and L2 are designed to have the same inductance value (L1=L2). The common use of the magnetic core expects a difference between L1 and L2 caused by an element variation to be suppressed. Further, as illustrated, the first winding (reactor L1) and the second winding (reactor L2) are magnetically coupled in reverse polarity.

It is to be noted that a variety of configurations are applicable to reactors L1 and L2 and reactor L3 as long as the configurations are electrically equivalent to FIG. 1. For example, it is unnecessary to configure reactors L1 and L2 and reactor L3 by strictly separating magnetic coupling transformer Tr (L1 and L2) and the smoothing reactor (L3). As an example, it is also possible to configure at least a portion of the inductance of smoothing reactor L3 by using the leakage inductance of magnetic coupling transformer Tr. In other words, the inductance of reactor L3 is expressed as the sum of the inductance of reactor L3 and the leakage inductance of magnetic coupling transformer Tr.

It is preferable to use magnetic cores different in material quality for magnetic coupling transformer Tr and smoothing reactor L3. Specifically, it is preferable to use a material that has less core loss in the case of AC excitation for the magnetic core of magnetic coupling transformer Tr because the interlinkage magnetic fluxes generated in magnetic coupling transformer Tr chiefly include AC magnetic fluxes. In contrast, the interlinkage magnetic fluxes generated in smoothing reactor L3 chiefly include DC magnetic fluxes. It is thus preferable to use a material having high saturation flux density and favorable DC superimposition characteristics for the magnetic core of reactor L3. The use of the different core materials as described above makes it possible to achieve even reductions in loss and decreases in size for magnetic coupling transformer Tr (reactors L1 and L2) and smoothing reactor L3.

It is to be noted that it is also possible in principle to include only the leakage inductance of magnetic coupling transformer Tr in reactor L3, but it is necessary to secure inductance necessary for smoothing.

A current detector 11 is disposed to detect a reactor current IL1 that flows in the first winding (reactor L1) of the magnetic coupling transformer. A current detector 12 is disposed to detect a reactor current IL2 that flows in the second winding (reactor L2) of the magnetic coupling transformer.

Semiconductor element D1 is connected between node N1 and an output node No. Semiconductor element D2 is connected between node N2 and output node No. Semiconductor element S1 is connected between node N1 and reference voltage node Ng. Semiconductor element S2 is connected between node N2 and reference voltage node Ng.

Semiconductor elements S1 and S2 and semiconductor elements D1 and D2 each include a semiconductor switching element (that will also be referred to simply as a “switching element” below) or a diode. It is possible to include, for example, a MOSFET (Metal Oxide Semiconductor Field Effect Transistor), an IGBT (Insulated Gate Bipolar Transistor), or the like in each of the switching elements. The switching elements are each subjected to ON/OFF control in accordance with a control signal from control unit 20.

In the configuration example of FIG. 1, the cathodes of semiconductor elements D1 and D2 are connected to output node No. In other words, semiconductor elements D1 and D2 include diodes that use the directions from nodes N1 and N2 to output node No (high-voltage-side terminal HV) as forward directions. On the other hand, semiconductor elements S1 and S2 each include a switching element that is subjected to ON/OFF control by control unit 20. This allows DC voltage conversion circuit 10 to perform a step-up (boost) operation of stepping up the DC voltage of low-voltage-side terminal LV and outputting the stepped-up DC voltage to high-voltage-side terminal HV. The following also refers to semiconductor elements S1 and S2 as switching elements S1 and S2.

DC voltage conversion circuit 10 performs an interleaving operation on a first-phase converter (boost chopper in FIG. 1) and a second-phase converter (boost chopper in FIG. 1) to execute DC/DC conversion between low-voltage-side terminal LV and high-voltage-side terminal HV. The first-phase converter includes semiconductor elements S1 and D1, and reactor L1. The second-phase converter includes semiconductor elements S2 and D2, and reactor L2.

Control unit 20 outputs PWM (Pulse Width Modulation) signals for controlling reactor currents IL1 and IL2 as pulsed driving signals for commanding semiconductor elements S1 and S2 to be turned on and off. The driving signals are input to a driver (not illustrated) that drives the gate voltages of semiconductor elements S1 and S2. This subjects switching elements S1 and S2 to ON/OFF control (control to switch) in accordance with output signals of control unit 20.

In the configuration example of FIG. 1, low-voltage-side terminal LV corresponds to an example of a “first terminal” and high-voltage-side terminal HV corresponds to an example of a “second terminal”. Further, reactor L1, reactor L2, and reactor L3 correspond to examples of a “first reactor”, a “second reactor”, and a “third reactor”, respectively. In addition, node N1 and node N2 correspond to examples of a “first node” and a “second node” and node Nt corresponds to an example of an “intermediate node”. Further, semiconductor element S1 and semiconductor element S2 correspond to examples of a “first semiconductor element” and a “second semiconductor element”, respectively. In FIG. 1 in particular, semiconductor element (switching element) S1 corresponds to a “first switching element” and semiconductor element (switching element) S2 corresponds to a “second switching element”. In addition, semiconductor element D1 corresponds to an example of a “third semiconductor element” and semiconductor element D2 corresponds to an example of a “fourth semiconductor element”.

FIG. 2 illustrates a hardware configuration example of control unit 20. Typically, it is possible to include a microcomputer in control unit 20. The microcomputer stores a predetermined program in advance.

For example, as illustrated in FIG. 2, it is possible to adopt a computer-based configuration in which control unit 20 includes a CPU (Central Processing Unit) 22, a memory 24, and an input/output (I/O) circuit 26. It is possible to exchange data between CPU 22, memory 24, and I/O circuit 26 through a bus 25. A partial region of memory 24 stores a program in advance. CPU 22 executes the program to make it possible to execute reactor current control described below. I/O circuit 26 receives and outputs signals and data from and to the outside of control unit 20 (e.g., current detectors 11 and 12 and switching elements S1 and S2).

Alternatively, different from the example of FIG. 2, it is possible to configure at least a portion of control unit 20 by using a circuit such as an FPGA (Field Programmable Gate Array) or an ASIC (Application Specific Integrated Circuit). In addition, it is also possible to configure at least a portion of control unit 20 by using an analog circuit. In this way, it is possible to implement functions of the respective blocks included in each of the functional block diagrams of control unit 20 described below by using at least one of software processing and hardware processing.

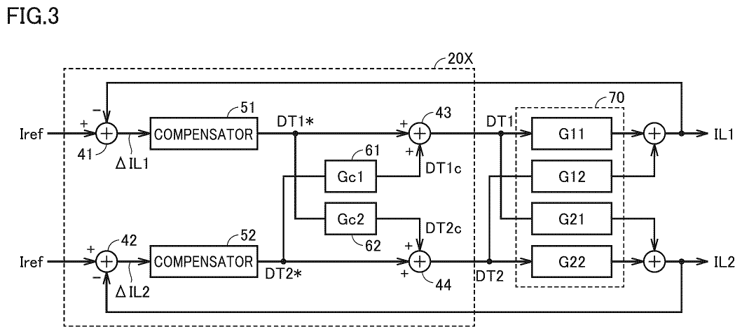

FIG. 3 is a current control block diagram of DC voltage conversion circuit 10 by control unit 20. As described above, at least one of software processing and hardware processing allows control unit 20 to configure a current controller 20X for controlling reactor currents IL1 and IL2 at a current command value Iref.

As illustrated in FIG. 3, current controller 20X calculates duty ratios DT1 and DT2 as the operation amounts of DC voltage conversion circuit 10 for matching respective reactor currents IL1 and IL2 detected by current detectors 11 and 12 with current command value Iref.

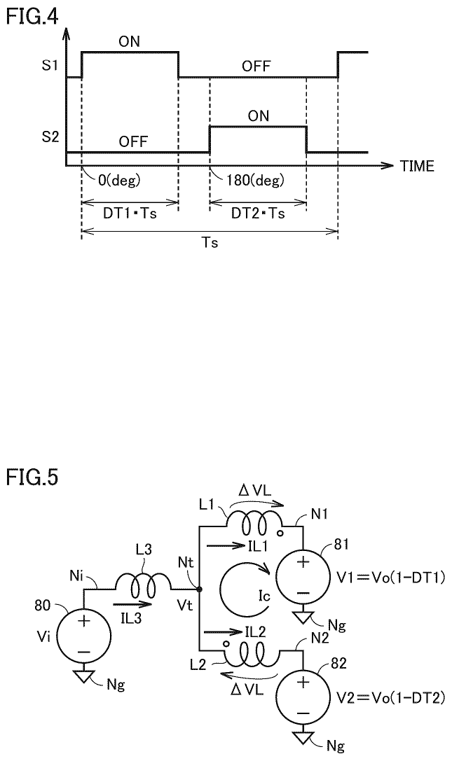

FIG. 4 illustrates a waveform chart describing an interleaving operation of the power converter according to the first embodiment. With reference to FIG. 4, the definitions of duty ratios DT1 and DT2 calculated by control unit 20 will also be described.

As illustrated in FIG. 4, when switching element S1 is considered to have a switching cycle length Ts of 360 (deg), switching element S1 is turned on in each switching cycle at the timing of a phase of 0 (deg) and turned off at the timing at which DT1·Ts passes after switching element S1 is turned on. Similarly, switching element S2 is turned on in each switching cycle at the timing of a phase of 180 (deg) and turned off at the timing at which DT2·Ts passes after switching element S2 is turned on.

In other words, switching elements S1 and S2 are subjected to ON/OFF control to be provided with a phase difference between the turn-on timings whenever switching cycle length Ts passes. This achieves an interleaving operation for suppressing a ripple current and a ripple voltage that are generated in capacitor C1 to make it possible to decrease the capacitance value of capacitor C1, that is, decrease capacitor C1 in size. It is to be noted that, setting the phase difference described above at 180 as in the example of FIG. 4 makes it possible to maximize the ripple suppression effect of the interleaving operation.

Duty ratio DT1 is defined as the ratio of the ON period length of switching element S1 to switching cycle length Ts. Similarly, duty ratio DT2 is defined as the ratio of the ON period length of switching element S2 to switching cycle length Ts. FIG. 4 illustrates an example in which duty ratios DT1 and DT2 fall within the range of 0≤DT1 (DT2)<0.5, but duty ratios DT1 and DT2 are variably controlled within the range of 0≤DT1 (DT2)<1 in accordance with the boost ratios.

FIG. 3 will be referenced again. A transfer function 70 indicates the change characteristics of reactor currents IL1 and IL2 with respect to duty ratios DT1 and DT2 in DC voltage conversion circuit 10. Reactor current IL1 receives not only the direct influence of ON/OFF control over switching element S1 that complies with duty ratio DT1, but also the influence of a change in reactor current IL2 through magnetic coupling transformer Tr. As a result, reactor current IL1 is expressed as a formula (1) below by using not only a transfer function G11, but also a transfer function G12. Transfer function G11 indicates a change characteristic of reactor current IL1 with respect to duty ratio DT1. Transfer function G12 indicates a change characteristic of reactor current IL1 with respect to duty ratio DT2.

$$IL 1 = G 11 \cdot DT 1 + G 12 \cdot DT 2 \qquad ( 1 )$$

Similarly, reactor current IL2 is expressed as a formula (2) below by using not only a transfer function G22, but also a transfer function G21. Transfer function G22 indicates a change characteristic of reactor current IL2 with respect to duty ratio DT2. Transfer function G21 indicates a change characteristic of reactor current IL2 with respect to duty ratio DT1.

$$IL 2 = G 22 \cdot DT 2 + G 21 \cdot DT 1 \qquad ( 2 )$$

In this way, transfer function 70 of DC voltage conversion circuit 10 includes transfer functions G11, G12, G21, and G22 including the mutual interference between reactor currents IL1 and IL2.

Current controller 20X includes subtractors 41 and 42, adders 43 and 44, compensators 51 and 52, and non-interference controllers 61 and 62.

Subtractor 41 subtracts the value of reactor current IL1 detected by current detector 11 from current command value Iref to calculate a current deviation ΔIL1. Similarly, subtractor 42 subtracts the value of reactor current IL2 detected by current detector 12 from current command value Iref to calculate a current deviation ΔIL2. Current deviations ΔIL1 and ΔIL2 are respectively input to compensators 51 and 52.

Compensator 51 calculates a basic duty ratio DT1* for compensating for current deviation ΔIL1. Similarly, compensator 52 calculates a basic duty ratio DT2* for compensating for current deviation ΔIL2. For example, each of compensators 51 and 52 makes a calculation under PI (Proportional Integral) control, PID (Proportional Integral Differential) control, or the like. Compensators 51 and 52 are normally designed to offer desired frequency characteristics for securing the responsiveness and the stability of DC voltage conversion circuit 10. For example, the frequency characteristics are adjusted with a gain of the PI control or the PID control described above.

Non-interference controller 61 multiplies basic duty ratio DT2* and a non-interfering coefficient Gc1 to calculate a correction amount DT1c of duty ratio DT1 for non-interference control. As described below, correction amount DT1c is set to cancel the amount of changes made in reactor current IL1 in accordance with a change in duty ratio DT2 through the magnetic coupling between reactors L1 and L2. Similarly, non-interference controller 62 multiplies basic duty ratio DT1* and a non-interfering coefficient Gc2 to calculate a correction amount DT2c of duty ratio DT2 for non-interference control. Correction amount DT2c is set to cancel the amount of changes made in reactor current IL2 in accordance with a change in duty ratio DT1 through the magnetic coupling.

Adder 43 adds basic duty ratio DT1* from compensator 51 and correction amount DT1c from non-interference controller 61 together to calculate duty ratio DT1 of switching element S1 (DT1=DT1*+DT1c). Similarly, adder 44 adds basic duty ratio DT2* from compensator 52 and correction amount DT2c from non-interference controller 62 together to calculate duty ratio DT2 of switching element S2 (DT2=DT2*+DT2c).

As described in FIG. 3, the ratios of the ON periods of switching elements S1 and S2 to switching cycle length Ts are controlled in accordance with calculated duty ratios DT1 and DT2. It is possible to generate ON/OFF control signals of switching elements S1 and S2 under PWM control as described below.

In the configuration example of FIG. 3, reactor currents IL1 and IL2 correspond to examples of a “first reactor current” and a “second reactor current”, respectively. In addition, duty ratio DT1 corresponds to an example of a “first operation amount” and correction amount DT1c corresponds to a “correction amount of the first operation amount”. Similarly, duty ratio DT2 corresponds to an example of a “second operation amount” and correction amount DT2c corresponds to a “correction amount of the second operation amount”. In addition, compensator 51 and non-interference controller 61 correspond to examples of a “first compensator” and a “first non-interference controller”, respectively, and compensator 52 and non-interference controller 62 correspond to examples of a “second compensator” and a “second non-interference controller”, respectively.

Next, the derivation of non-interfering coefficients Gc1 and Gc2 that are used by non-interference controllers 61 and 62 will be described.

It is possible to obtain non-interfering coefficient Gc1 from a formula (3) below by using a change coefficient (∂IL1/∂DT1) of reactor current IL1 with respect to a change in duty ratio DT1 and a change coefficient (∂IL1/∂DT2) of reactor current IL1 with respect to a change in duty ratio DT2. Non-interfering coefficient Gc1 corresponds to a “first non-interfering coefficient”.

$$Gc 1 = - ( \partial IL 1 / \partial DT 2 ) / ( \partial IL 1 / \partial DT 1 ) \qquad ( 3 )$$

Similarly, it is possible to obtain non-interfering coefficient Gc2 from a formula (4) below by using a change coefficient (∂IL2/∂DT1) of reactor current IL2 with respect to a change in duty ratio DT1 and a change coefficient (∂IL2/∂DT2) of reactor current IL2 with respect to a change in duty ratio DT2. Non-interfering coefficient Gc2 corresponds to a “second non-interfering coefficient”.

$$Gc 2 = - ( \partial IL 2 / \partial DT 1 ) / ( \partial IL 2 / \partial DT 2 ) \qquad ( 4 )$$

FIG. 5 illustrates an equivalent circuit diagram of DC voltage conversion circuit 10 for analyzing relationships between duty ratios DT1 and DT2 and reactor currents IL1 and IL2.

As illustrated in FIG. 5, it is possible to illustrate DC voltage conversion circuit 10 with an equivalent circuit in which a voltage source 81 of an output voltage V1 depending on duty ratio DT1 is connected between node N1 and reference voltage node Ng and a voltage source 82 of an output voltage V2 depending on duty ratio DT2 is connected between node N2 and reference voltage node Ng. It is possible to express output voltage V1 by using a voltage Vo of output node No as the voltage average value of node N1 with V1=Vo (1−DT1). Similarly, it is possible to express output voltage V2 as the voltage average value of node N2 with V2=Vo (1−DT2).

Further, in this equivalent circuit, a voltage source 80 of an output voltage Vi is connected between input node N1 and reference voltage node Ng. Voltage source 80 corresponds to DC supply 5 illustrated in FIG. 1. Output voltage Vi is a constant.

A current Ic illustrated in the equivalent circuit corresponds to a current that passes through both reactors L1 and L2 and causes mutual interference. The inductances of reactors L1 and L2 that are magnetically coupled are equal (L1=L2). It is thus possible to express current Ic by using the voltage difference (V2−V1) and inductance L1 as Ic=(V2−V1)/(4·s·L1). The substitution of V1 and V2 expressed above with duty ratios DT1 and DT2 makes it possible to obtain a formula (5) below. It is to be noted that “s” in the formula represents a differential operator of the Laplace transform.

$$[ Expression 1 ]$$

$$Ic = \frac{V 2 - V 1}{4 s L 1} = \frac{V o ( D T 1 - D T 2 )}{4 s L 1} \qquad ( 5 )$$

In addition, it is possible to express, by using a voltage Vt of node Nt, a reactor current IL3 that flows in reactor L3 as IL3=(Vi−Vt)/(s·L3). Here, current Ic causes both ends of reactors L1 and L2 to have ΔVL in reverse polarity. This satisfies Vt=V1−ΔVL=V2+ΔVL. This results in the expressions of ΔVL=(V1+V2)/2 and Vt=V2+ΔVL=Vo (1−(DT1+DT2)/2). As a result, it is possible to express reactor current IL3 with a formula (6) below.

$$[ Expression 2 ]$$

$$IL3 = \frac{Vi - Vt}{s L 3} = \frac{2 Vi + Vo ( D T 1 + D T 2 - 2 )}{2 s L 3} \qquad ( 6 )$$

Further, if L1=L2 is taken into consideration, it is possible to express reactor current IL1 by using reactor current IL3 and current Ic as IL1=IL3/2+Ic. The substitution of formula (5) and formula (6) described above allows reactor current IL1 to be expressed with a formula (7) below in which duty ratios DT1 and DT2 are variables.

$$[ Expression 3 ]$$

$$IL 1 = \frac{1}{2} IL 3 + Ic = \frac{2 Vi + Vo ( DT 1 + DT 2 - 2 )}{4 s L 3} + \frac{Vo ( D T 1 - D T 2 )}{4 s L 1} = \frac{1}{s} \{ \frac{V i - V o}{2 L 3} + ( \frac{V o}{4 L 3} + \frac{V o}{4 L 1} ) DT 1 + ( \frac{Vo}{4 L 3} - \frac{Vo}{4 L 1} ) DT 2 \} \qquad ( 7 )$$

Formula (7) is partially differentiated with respect to reactor currents IL1 and IL2 to allow non-interfering coefficient Gc1 in formula (3) described above to be obtained in accordance with a formula (8) below.

$$[ Expression 4 ]$$

$$G c 1 = - \frac{\frac{\partial IL 1}{\partial D T 2}}{\frac{\partial IL 1}{\partial D T 1}} = - \frac{\frac{1}{L 3} - \frac{1}{L 1}}{\frac{1}{L 3} + \frac{1}{L 1}} = \frac{L 3 - L 1}{L 1 + L 3} \qquad ( 8 )$$

Similarly, it is possible to express reactor current IL2 by using reactor current IL3 and current Ic as IL2=IL3/2−Ic. The substitution of formula (5) and formula (6) described above thus allows reactor current IL2 to be expressed with a formula (9) below in which duty ratios DT1 and DT2 are variables.

$$[ Expression 5 ]$$

$$IL 2 = \frac{1}{2} IL 3 - Ic = \frac{2 Vi + V o ( D T 1 + D T 2 - 2 )}{4 s L 3} + \frac{V o ( D T 2 - D T 1 )}{4 s L 2} = \frac{1}{s} \{ \frac{V i - V o}{2 L 3} + ( \frac{V o}{4 L 3} - \frac{V o}{4 L 2} ) D T 1 + ( \frac{V o}{4 L 3} + \frac{V o}{4 L 2} ) D T 2 \} \qquad ( 9 )$$

Formula (9) is partially differentiated with respect to reactor currents IL1 and IL2 to allow non-interfering coefficient Gc2 in formula (4) described above to be obtained in accordance with a formula (10) below.

$$[ Expression 6 ]$$

$$G c 2 = - \frac{\frac{\partial IL 2}{\partial D T 1}}{\frac{\partial IL 2}{\partial D T 2}} = - \frac{\frac{1}{L 3} - \frac{1}{L 2}}{\frac{1}{L 3} + \frac{1}{L 2}} = \frac{L 3 - L 2}{L 2 + L 3} \qquad ( 10 )$$

It is understood from formula (8) and formula (10) that the polarities (positive/negative) of non-interfering coefficients Gc1 and Gc2 depend on the magnitude relationship between the inductances (L1=L2) of reactors L1 and L2 and the inductance (L3) of reactor L3.

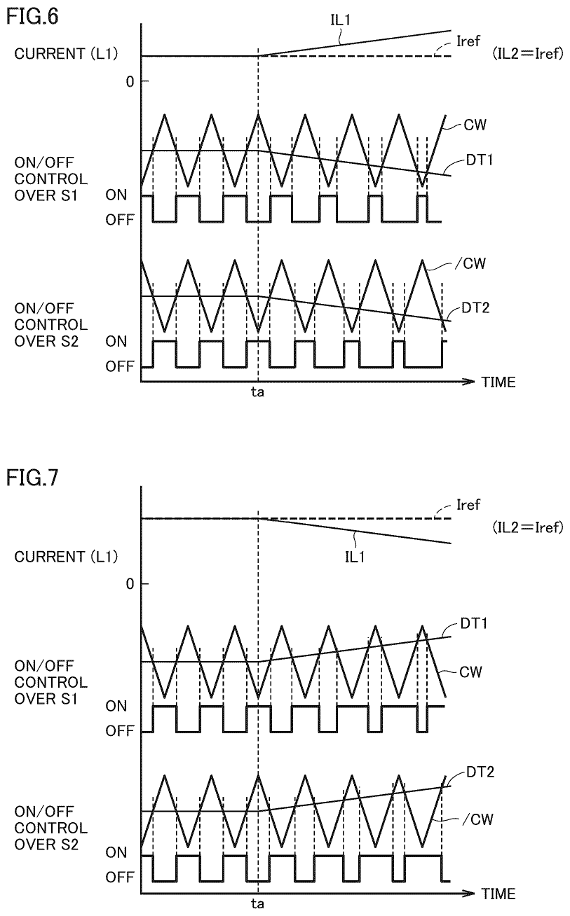

Next, with reference to FIGS. 6 to 9, operation examples of non-interference control in the power converter according to the first embodiment will be described. FIGS. 6 and 7 illustrate examples of control performed when L3>L1 and L2 holds.

With reference to FIG. 6, PWM control for performing control to turn on and off switching elements S1 and S2 will be first described. The PWM control is common to FIGS. 6 to 9.

Switching element S1 is turned on and off based on a comparison indicating which of duty ratio DT1 and a carrier wave CW is larger. The difference between the maximum value and the minimum value of carrier wave CW corresponds to the maximum values (1.0) of duty ratios DT1 and DT2. Specifically, switching element S1 is turned on in a period of DT1≥CW. In contrast, switching element S1 is turned off in a period of DT1<CW. It is understood from this that the ON period ratio of switching element S1 increases as duty ratio DT1 calculated by current controller 20X increases.

Similarly, switching element S2 is turned on and off based on a comparison indicating which of duty ratio DT1 and a carrier wave/CW is larger. Carrier wave/CW has a phase difference of 180 (deg) from carrier wave CW. Carrier wave/CW is an inverted signal of carrier wave CW. Switching element S2 is turned on in a period of DT1≥/CW. In contrast, switching element S2 is turned off in a period of DT1</CW. It is understood from this that the ON period ratio of switching element S2 increases as duty ratio DT2 calculated by current controller 20X increases.

In addition, PWM control is performed on switching elements S1 and S2 by using carrier waves CW and/CW having a phase difference of 180 (deg). This makes it possible to provide a phase difference of 180 (deg) between operations of switching elements S1 and S2 as illustrated in FIG. 3. In the configuration example of FIG. 2, the boost ratios increase and reactor currents IL1 and IL2 also increase in DC voltage conversion circuit 10 as duty ratios DT1 and DT2 are set to be higher.

In the operation example of FIG. 6, duty ratios DT1 and DT2 are substantially constant until time ta under the control of IL1=Iref and IL2=Iref. An operation of non-interference control is illustrated that is performed while reactor current IL1 is increasing with respect to current command value Iref after time ta. It is to be noted that IL2=Iref is considered to be kept even after time ta.

When reactor current IL1 increases (IL1>Iref), basic duty ratio DT1* increases from the value at time ta in accordance with current deviation ΔIL1<0 in FIG. 5. In contrast, basic duty ratio DT2* for controlling reactor current IL2 is kept at the value at time ta because LL2=Iref is kept.

Correction amount DT1c does not thus change from the value at time ta even after time ta. Duty ratio DT1 of switching element S1 thus decreases in accordance with a decrease in basic duty ratio DT1* corresponding to current deviation ΔIL1.

In this case, current controller 20X is operated in the equivalent circuit in FIG. 4 to increase output voltage V1 of voltage source 81 by decreasing duty ratio DT1 to decrease reactor current IL1. The decrease in duty ratio DT1 serves to increase reactor current IL2 in the case of L3>L1 and L2. Without non-interference control, an operation of compensator 51 for compensating for current deviation ΔIL1 thus increases reactor current IL2 kept at current command value Iref.

In the present embodiment in which non-interference control is executed, a change in duty ratio DT1 is reflected in correction amount DT2c of duty ratio DT2 by using non-interfering coefficient Gc2 of non-interference controller 62. As described above, L3>L1 and L2 holds in FIG. 6. Non-interfering coefficient Gc2 is thus positive (Gc2>0) in accordance with formula (10). Non-interference controller 62 thus decreases correction amount DT2c as duty ratio DT1 decreases. This also decreases duty ratio DT2 (DT2=DT2*+DT2c) from the value at time ta. This makes it possible to suppress an increase in reactor current IL2 brought about by the influence of a decrease in duty ratio DT1 caused by magnetic coupling in magnetic coupling transformer Tr.

This makes it possible to suppress the mutual interference between reactor currents IL1 and IL2 caused by the magnetic coupling in magnetic coupling transformer Tr and then suppress a current imbalance by controlling reactor currents IL1 and IL2 at current command value Iref.

The operation example of FIG. 7 is opposed to the operation example of FIG. 6. An operation of non-interference control is illustrated that is performed while reactor current IL1 is increasing with respect to current command value Iref after time ta. Even in the operation example of FIG. 7, the behavior at or before time ta is similar to that of FIG. 6. In addition, IL2=Iref is considered to be kept even after time ta.

In FIG. 7, basic duty ratio DT1* increases from the value at time ta as reactor current IL1 decreases (IL1<Iref). In contrast, basic duty ratio DT2* for controlling reactor current IL2 is kept at the value at time ta as in FIG. 6. Duty ratio DT1 of switching element S1 thus increases after time ta in accordance with an increase in basic duty ratio DT1* corresponding to current deviation ΔIL1.

Even in the operation example of FIG. 7, a change in duty ratio DT1 is reflected in correction amount DT2c of duty ratio DT2 by using non-interfering coefficient Gc2 (Gc2>0) similar to that of FIG. 6. Correction amount DT2c is thus increased as duty ratio DT1 increases. As opposed to FIG. 6, duty ratio DT2 increases from the value at time ta. This makes it possible to suppress a decrease in reactor current IL2 brought about by the influence of an increase in duty ratio DT1 caused by magnetic coupling in magnetic coupling transformer Tr.

This makes it possible to suppress the mutual interference between reactor currents IL1 and IL2 as in the operation example of FIG. 6 and then suppress a current imbalance by controlling reactor currents IL1 and IL2 at current command value Iref.

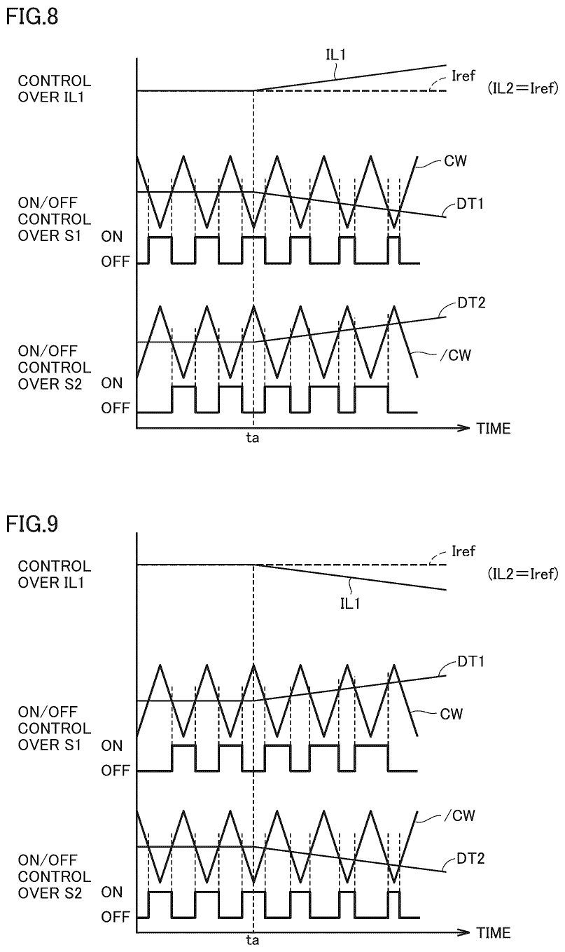

Next, FIGS. 8 and 9 illustrate examples of control performed when L3<L1 and L2 holds as opposed to FIGS. 6 and 7.

The transition of reactor current IL1 in FIG. 8 is similar to that of FIG. 6. In other words, reactor current IL1 increases with respect to current command value Iref after time ta. Further, IL2=Iref is kept even after time ta.

In FIG. 8, basic duty ratio DT1* decreases from the value at time ta as reactor current IL1 increases (LL1>Iref). This decreases duty ratio DT1 of switching element S1 after time ta as in FIG. 6 in accordance with a decrease in basic duty ratio DT1* corresponding to current deviation ΔIL1.

In the equivalent circuit in FIG. 4, an increase in output voltage V1 of voltage source 81 brought about by a decrease in duty ratio DT1 serves to decrease reactor current IL2 in the case of L3<L1 and L2.

As understood from formula (10), non-interfering coefficient Gc2 is negative (Gc2<0) when L3<L1 and L2 holds. Non-interference controller 62 thus increases correction amount DT2c in FIG. 8 as duty ratio DT1 decreases. This increases duty ratio DT2 (DT2=DT2*+DT2c) from the value at time ta as opposed to FIG. 6.

This suppresses a decrease in reactor current IL2 brought about by the influence of a decrease in duty ratio DT1 caused by magnetic coupling in magnetic coupling transformer Tr.

The transition of reactor current IL1 in FIG. 9 is similar to that of FIG. 7. In other words, reactor current IL1 decreases with respect to current command value Iref after time ta. Further, IL2=Iref is kept even after time ta.

In FIG. 9, basic duty ratio DT1* increases from the value at time ta as reactor current IL1 decreases (LL1<Iref). This increases duty ratio DT1 of switching element S1 after time ta as in FIG. 7 in accordance with an increase in basic duty ratio DT1* corresponding to current deviation ΔIL1.

Even in the operation example of FIG. 9, a change in duty ratio DT1 is reflected in correction amount DT2c of duty ratio DT2 by using non-interfering coefficient Gc2 (Gc2<0) similar to that of FIG. 8. Correction amount DT2c is thus decreased as duty ratio DT1 increases. As opposed to FIG. 8, duty ratio DT2 decreases from the value at time ta. This makes it possible to suppress an increase in reactor current IL2 brought about by the influence of an increase in duty ratio DT1 caused by magnetic coupling in magnetic coupling transformer Tr.

In this way, the introduction of non-interference control that uses non-interfering coefficients Gc1 and Gc2 makes it possible to cancel a current change (i.e., mutual interference) in one of reactor currents IL1 and IL2 caused by a current change in the other in the power converter according to the first embodiment. As exemplified in FIGS. 6 to 9, when reactor current IL1 changes, duty ratio DT1 is changed by a change in an output of compensator 51. It is, however, possible to change duty ratio DT2 in conjunction with this in accordance with the absolute value and the polarity of non-interfering coefficient Gc2. This makes it possible to cancel the change in reactor current IL2 caused by the change in duty ratio DT1.

Similarly, when reactor current IL2 changes, duty ratio DT2 is changed by a change in an output of compensator 52. It is, however, possible to change duty ratio DT1 in conjunction with this in accordance with the absolute value and the polarity of non-interfering coefficient Gc1. This makes it possible to cancel the change in reactor current IL2 caused by the change in duty ratio DT1.

It is to be noted that, when both reactor currents IL1 and IL2 deviate from current command value Iref, the combination of the two cases described above makes it possible to calculate duty ratios DT1 and DT2 in accordance with the block diagram of FIG. 3.

Here, control is assumed that does not have non-interfering coefficients Gc1 and Gc2 introduced thereto. When reactor current IL1 changes, duty ratio DT1 changes as an output of compensator 51 changes. The influence of this change then changes reactor current IL2 regardless of an output (duty ratio DT2) of compensator 52. Similarly, when reactor current IL2 changes, duty ratio DT2 changes as an output of compensator 52 changes. The influence of this change then changes reactor current IL1 regardless of an output (duty ratio DT1) of compensator 51. In other words, outputs of both compensators 51 and 52 influence control over respective reactor currents IL1 and IL2. It is thus necessary to design each of compensators 51 and 52 with two variables. This complicates the design of a control system for obtaining the desired frequency characteristics.

In contrast, the introduction of the non-interference control described above allows the power converter according to the first embodiment to cancel the influence of a change in an output of compensator 51 or 52 for controlling one of reactor currents IL1 and IL2 on the other of the currents. This makes it possible to design each of compensators 51 and 52 with a single variable.

As a result, it is possible to obtain the desired frequency characteristics with ease by control design decided with a transfer function of a main circuit alone. Specifically, in FIG. 3, the frequency characteristics of a control loop of reactor current IL1 are determined only by the product of compensator 51 and transfer function G11 without the influence of transfer function G12. Similarly, the frequency characteristics of a control loop of reactor current IL2 are determined only by the product of compensator 52 and transfer function G22 without the influence of transfer function G21. As a result, it is possible to simplify the design for obtaining the desired frequency characteristics. In addition, as described in formulae (8) and (10), non-interfering coefficients Gc1 and Gc2 are simple constants decided by the inductances of reactors L1 to L3. This makes it possible to implement non-interfering coefficients Gc1 and Gc2 in control unit 20 with ease.

Further, when the adjustment of a coupling coefficient of magnetic coupling transformer Tr causes the inductances of reactors L1 to L3 to be the same value, Gc1=Gc2=0 holds in accordance with formulae (8) and (10). In other words, the circuit design in which L1=L2=L3 holds makes it possible to control even reactor currents IL1 and IL2 in the block diagram of FIG. 3 with non-interference controllers 61 and 62 equivalently out of use (Gc1=Gc2=0).

### Second Embodiment

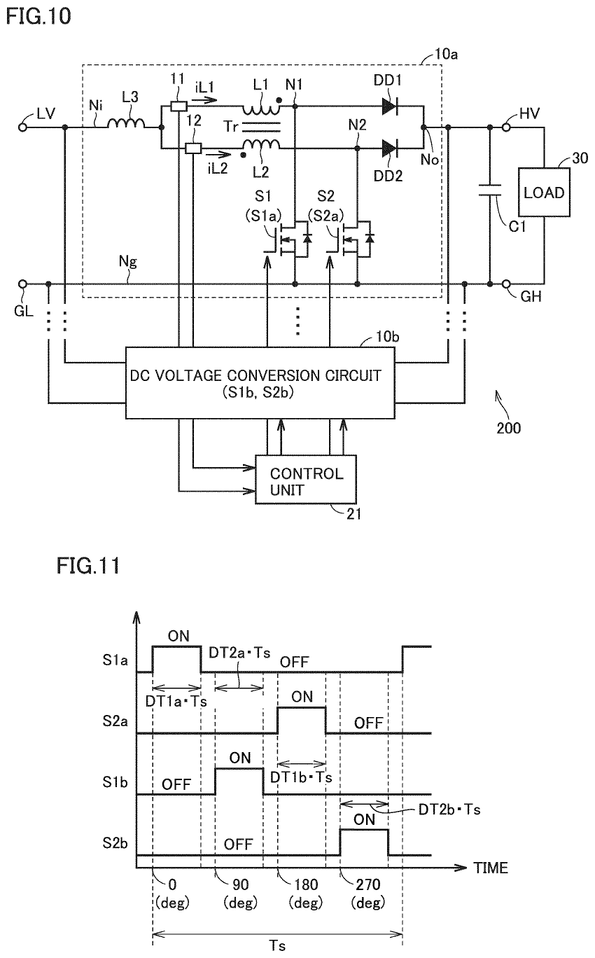

FIG. 10 is a circuit diagram describing a configuration of a power converter according to a second embodiment.

As illustrated in FIG. 10, a power converter 200 according to the second embodiment includes N DC voltage conversion circuits 10 (N: an integer that is 2 or more) according to the first embodiment and further includes a control unit 21. N DC voltage conversion circuits 10 are connected in parallel between low-voltage-side terminal LV and grounding terminal GL that are connected to DC supply 5 and high-voltage-side terminal HV and grounding terminal GH that are connected to load 30 and capacitor C1. Control unit 21 receives reactor currents IL1 and IL2 of each of N DC voltage conversion circuits 10 and performs control to turn on and off semiconductor elements S1 and S2 of each of N DC voltage conversion circuits 10.

FIG. 10 illustrates an example in which N=2 holds. Power converter 200 includes DC voltage conversion circuits 10a and 10b that are connected in parallel and control unit 21 that controls DC voltage conversion circuits 10a and 10b.

Input node Ni of each of DC voltage conversion circuits 10a and 10b is connected to low-voltage-side terminal LV. Output node No of each of DC voltage conversion circuits 10a and 10b is connected to high-voltage-side terminal HV. In addition, reference voltage node Ng of each of DC voltage conversion circuits 10a and 10b is connected to grounding terminals GL and GH.

As described in the first embodiment, control unit 21 calculates, for each of DC voltage conversion circuits 10a and 10b, duty ratios DT1 and DT2 for controlling reactor currents IL1 and IL2 at current command value Iref. In each of DC voltage conversion circuits 10a and 10b, non-interference controllers 61 and 62 illustrated in FIG. 3 are thus introduced to calculate duty ratios DT1 and DT2. Control unit 21 has control functions corresponding to those of the current control block diagram illustrated in FIG. 3 for each of DC voltage conversion circuits 10a and 10b. Duty ratios DT1 and DT2 are individually calculated in DC voltage conversion circuits 10a and 10b.

FIG. 11 illustrates a waveform chart describing an interleaving operation of the power converter according to the second embodiment. FIG. 11 describes switching elements S1 and S2 in DC voltage conversion circuit 10a as S1a and S2a and describes switching elements S1 and S2 in DC voltage conversion circuit 10b as S1b and S2b.

Further, the respective duty ratios (ON period ratios) of switching elements S1a, S2a, S1b, and S2b are described as DT1a, DT2a, DT1b, and DT2b. Duty ratios DT1a and DT2a are calculated based on the values of detected reactor currents IL1 and IL2 in DC voltage conversion circuit 10a by using the current control block diagram of FIG. 3. Similarly, duty ratios DT1b and DT2b are calculated based on the values of detected reactor currents IL1 and IL2 in DC voltage conversion circuit 10b by using the current control block diagram of FIG. 3.

Switching elements S1a and S2a of DC voltage conversion circuit 10a and switching elements S1b and S2b of DC voltage conversion circuit 10b have a common switching frequency. The switching cycle length thereof is Ts.

As in the first embodiment, switching elements S1a and S2a of DC voltage conversion circuit 10a are subjected to ON/OFF control to have a phase difference of 180 (deg). In addition, switching elements S1b and S2b of DC voltage conversion circuit 10b are also subjected to ON/OFF control to have a phase difference of 180 (deg).

Further, in power converter 200, phase differences are set between the timings at which switching elements S1a and S2a of DC voltage conversion circuit 10a are turned on and off and the timings at which switching elements S1b and S2b of DC voltage conversion circuit 10b are turned on and off.

In the example of FIG. 11, switching cycle length Ts is set at 360 (deg). In each switching cycle of power converter 200, switching element S1a in DC voltage conversion circuit 10a is turned on at the timing of a phase of 0 (deg) and turned off at the timing at which DT1a·Ts passes after switching element S1a is turned on. Switching element S2a is turned on in each switching cycle at the timing of a phase of 180 (deg) and turned off at the timing at which DT2b·Ts passes after switching element S2a is turned on.

In contrast, switching element S1b in DC voltage conversion circuit 10b is turned on at the timing of a phase of 90 (deg) and turned off at the timing at which DT1b·Ts passes after switching element S1b is turned on. Switching element S2b is turned on in each switching cycle at the timing of a phase of 270 (deg) and turned off at the timing at which DT2b·Ts passes after switching element S2b is turned on.

In this way, in the configuration example of FIG. 9 in which N=2 holds, there are provided phase differences each set at 90 (deg) between the turn-on timings of the four switching elements of two DC voltage conversion circuits 10. This makes it possible to minimize the amplitudes of a ripple voltage and a ripple current generated in capacitor C1. It is to be noted that, when N=2 holds, duty ratios DT1a, DT2a, DT1b, and DT2b are variably controlled within the range of 0≤DT1a (DT2a, DT1b, and DT2b)<1.

In other words, it is understood that phase differences each set at 360 (deg)/(2·N) are set between the turn-on timings of the (2·N) switching elements in total in the configuration in which N DC voltage conversion circuits 10 according to the first embodiment are connected in parallel, thereby making it possible to maximize the ripple suppression effect brought about by an interleaving operation. However, even when the phase differences described above are each set at a value different from 360 (deg)/(2·N), it is still possible to obtain the ripple suppression effect.

In this way, the power converter according to the second embodiment makes it possible to further suppress a ripple voltage and a ripple current by performing an interleaving operation on the whole of the (2·N) switching elements in total in the configuration in which the N DC voltage conversion circuits according to the first embodiment are connected in parallel. As a result, it is possible to decrease capacitor C1 in size by increasing the ripple suppression effect brought about by an interleaving operation in addition to the effect of simplifying the control design in each DC voltage conversion circuit 10 described in the first embodiment.

In particular, providing 360/(2·N) respective phase differences between the turn-on timings of the (2·N) switching elements makes it possible to maximize the ripple suppression effect.

It is to be noted that the examples have been described in the first to third embodiments in which the plurality of switching elements in power converters 100 and 200 is subjected to ON/OFF control in accordance with common switching cycle length. It is understood that, when all the switching elements have the same switching cycle length, the ripple suppression effect described above is increased. The power converter according to the present embodiment is not, however, required to have strictly the same value for the switching cycle lengths of the respective switching elements. For example, a plurality of switching elements may have different switching cycle lengths for ON/OFF control within the range that allows the ripple suppression effect to be obtained.

In addition, the configuration example has been described above in which DC voltage conversion circuit 10 performs a step-up operation by adopting a configuration in which semiconductor elements S1 and S2 include the “switching elements” while semiconductor elements D1 and D2 include the “diodes”. It is, however, also possible to modify the configuration of DC voltage conversion circuit 10 as follows.

As a first modification example, it is possible to adopt, for DC voltage conversion circuit 10 (FIG. 2), a configuration in which semiconductor elements D1 and D2 include the “switching elements” while semiconductor elements S1 and S2 include the “diodes” in which the anodes are connected to reference voltage node Ng, that is, the directions from reference voltage node Ng to nodes N1 and N2 are used as forward directions. In this case, DC voltage conversion circuit 10 is capable of executing a step-down operation of stepping down the DC voltage of high-voltage-side terminal HV and outputting the stepped-down DC voltage to low-voltage-side terminal LV.

In the first modification example, it is possible to subject a switching element of semiconductor element D1 to ON/OFF control as with switching elements S1 in the first and second embodiments and subject a switching element of semiconductor element D2 to ON/OFF control as with switching elements S2 in the first and second embodiments. Performing ON/OFF control in this way makes it possible to enjoy an effect similar to that of any of the first and second embodiments with respect to the control over reactor currents IL1 and IL2 in DC/DC conversion that entails a step-down operation of DC voltage conversion circuit 10.

Alternatively, as a second modification example, it is also possible to adopt a configuration in which each of semiconductor elements S1, S2, D1, and D2 includes the “switching element” to which an anti-parallel diode is connected. In this case, DC voltage conversion circuit 10 is capable of executing both the step-up operation and the step-down operation described above.

In the second modification example, it is possible to subject a switching element of semiconductor element S1 to ON/OFF control as with switching elements S1 in the first and second embodiments and perform control to turn on and off a switching element of semiconductor element D1 complementarily to switching elements S1. Similarly, it is possible to subject a switching element of semiconductor element S2 to ON/OFF control as with switching elements S2 in the first and second embodiments and perform control to turn on and off a switching element of semiconductor element D1 complementarily to switching elements S1. Performing ON/OFF control in this way makes it possible to enjoy an effect similar to that of any of the first and second embodiments with respect to the control over reactor currents IL1 and IL2 in DC/DC conversion that entails a step-down operation or a step-up operation of DC voltage conversion circuit 10.

The embodiments disclosed herein should be understood as examples in all respects, but should not be understood as being restrictive. The technical scope of the present disclosure is defined not by the description above, but by the claims. The technical scope of the present disclosure is intended to include all modifications within the meaning and the scope equivalent to the claims.

### REFERENCE SIGNS LIST

5 DC supply; 10, 10a, 10b DC voltage conversion circuit; 11, 12 Current detector; 20, 21 Control unit; 20X Current controller; 24 Memory; 25 Bus; 26 I/O circuit; 30 Load; 41, 42 Subtractor; 43, 44 Adder; 51, 52 Compensator; 61, 62 Non-interference controller; 70, G11, G12, G21, G22 Transfer function; 80, 81, 82 Voltage source; 100, 200 Power converter; C1 Capacitor; CW, /CW Carrier wave; D1, D2 Semiconductor element (diode); DT1, DT1a, DT1b, DT2, DT2a, DT2b Duty ratio; DT1*, DT2* Basic duty ratio; DT1c, DT2c Correction amount (non-interference control); GH, GL Grounding terminal; GND Ground voltage; Gc1, Gc2 Non-interfering coefficient; HV High-voltage-side terminal; IL1 to IL3 Reactor current; Iref Current command value; L1 to L3 Reactor; LV Low-voltage-side terminal; Ng Reference voltage node; Ni Input node; No Output node; S1, S1a, S1b, S2a, S2b, S2 Semiconductor element (switching element); Tr Magnetic coupling transformer

1. A power converter comprising
a DC voltage conversion circuit that converts a DC voltage between a first terminal and a second terminal, wherein
the DC voltage conversion circuit includes
a first reactor that is connected between a first node and an intermediate node,
a second reactor that is connected between a second node and the intermediate node, the second reactor magnetically coupled to the first reactor in reverse polarity, and
a third reactor that is connected between an input node and the intermediate node, the input node being connected to the first terminal,
inductances of the first and second reactors are equivalent,
the DC voltage conversion circuit further includes
a first semiconductor element that is connected between a reference voltage node and the first node,
a second semiconductor element that is connected between the reference voltage node and the second node,
a third semiconductor element that is connected between the first node and the second terminal,
a fourth semiconductor element that is connected between the second node and the second terminal, and
a current detector that detects a first reactor current and a second reactor current, the first reactor current flowing to the first reactor, the second reactor current flowing to the second reactor,
one of the first and third semiconductor elements includes a first switching element,
one of the second and fourth semiconductor elements includes a second switching element,
the power converter further comprises a control unit that performs control to turn on and off the first and second switching elements to provide a phase difference between turn-on timings of the first and second switching elements,
the control unit includes a current controller that calculates a first operation amount and a second operation amount based on the first and second reactor currents detected by the current detector, the first operation amount defining an ON period of the first switching element, the second operation amount defining an ON period of the second switching element, and
the current controller is configured to calculate the first and second operation amounts with non-interference control for suppressing mutual interference between the first and second reactor currents, the mutual interference being caused by magnetic coupling between the first and second reactors.

2. The power converter according to claim 1, wherein
the current controller includes
a first compensator for calculating the first operation amount based on the first reactor current,
a second compensator for calculating the second operation amount based on the second reactor current,
a first non-interference controller that calculates a correction amount of the first operation amount based on the second operation amount calculated by the second compensator, the correction amount being for canceling an amount of changes made in the first reactor current in accordance with a change in the second operation amount through the magnetic coupling, and
a second non-interference controller that calculates a correction amount of the second operation amount based on the first operation amount calculated by the first compensator, the correction amount being for canceling an amount of changes made in the second reactor current in accordance with a change in the first operation amount through the magnetic coupling.

3. The power converter according to claim 2, wherein
respective ON period ratios of the first and second switching elements are set to be higher as the first and second operation amounts increase,
inductance of the third reactor is more than each of the inductances of the first and second reactors,
the first non-interference controller calculates the correction amount of the first operation amount to increase the first operation amount in conjunction with an increase in an output value of the second compensator and decrease the first operation amount in conjunction with a decrease in the output value of the second compensator, and
the second non-interference controller calculates the correction amount of the second operation amount to increase the second operation amount in conjunction with an increase in an output value of the first compensator and decrease the second operation amount in conjunction with a decrease in the output value of the first compensator.

4. The power converter according to claim 2, wherein
respective ON period ratios of the first and second switching elements are set to be higher as the first and second operation amounts increase,
inductance of the third reactor is less than each of the inductances of the first and second reactors,
the first non-interference controller calculates the correction amount of the first operation amount to decrease the first operation amount in conjunction with an increase in an output value of the second compensator and increase the first operation amount in conjunction with a decrease in the output value of the second compensator, and
the second non-interference controller calculates the correction amount of the second operation amount to decrease the second operation amount in conjunction with an increase in an output value of the first compensator and increase the second operation amount in conjunction with a decrease in the output value of the first compensator.

5. The power converter according to claim 2, wherein
respective ON period ratios of the first and second switching elements are set to be higher as the first and second operation amounts increase,
inductance of the third reactor is equivalent to each of the inductances of the first and second reactors, and
the first and second non-interference controllers each set the correction amount at zero.

6. The power converter according to claim 3, wherein
the first non-interference controller calculates the correction amount of the first operation amount in accordance with a product of an output value of the second compensator and a first non-interfering coefficient,
the second non-interference controller calculates the correction amount of the second operation amount in accordance with a product of an output value of the first compensator and a second non-interfering coefficient,
the first non-interfering coefficient is set as a positive value by using the inductances of the first and third reactors when the inductance of the third reactor is more than the inductance of the first reactor while the first non-interfering coefficient is set as a negative value by using the inductances of the first and third reactors when the inductance of the third reactor is less than the inductance of the first reactor,
the second non-interfering coefficient is set as a positive value by using the inductances of the second and third reactors when the inductance of the third reactor is more than the inductance of the second reactor while the second non-interfering coefficient is set as a negative value by using the inductances of the second and third reactors when the inductance of the third reactor is less than the inductance of the second reactor,
the first and second non-interfering coefficients are set at zero when the inductance of the third reactor is equivalent to each of the inductances of the first and second reactors,
the first operation amount is calculated by adding the output value of the first compensator and the correction amount together, the correction amount being calculated by the first non-interference controller, and
the second operation amount is calculated by adding the output value of the second compensator and the correction amount together, the correction amount being calculated by the second non-interference controller.

7. The power converter according to claim 6, wherein
when L1 represents the inductance of the first reactor, L2 represents the inductance of the second reactor, and L3 represents the inductance of the third reactor,
the first non-interfering coefficient is set in accordance with (L3−L1)/(L1+L3), and
the second non-interfering coefficient is set in accordance with (L3−L2)/(L2+L3).

8. The power converter according to claim 1, wherein the control unit performs control to turn on and off the first and second switching elements in accordance with same switching cycle length to cause the phase difference to be set as a half of the switching cycle length.

9. The power converter according to claim 1, wherein
the first and second reactors are configured using a magnetic coupling transformer including a first winding and a second winding that are wound around a common core,
the first winding is connected between the first node and the intermediate node, and
the second winding is connected between the second node and the intermediate node.

10. The power converter according to claim 9, wherein inductance of the third reactor includes leakage inductance of the magnetic coupling transformer.

11. The power converter according to claim 1, wherein
the first semiconductor element includes the first switching element,
the second semiconductor element includes the second switching element,
the third semiconductor element includes a diode that uses a direction from the first node to the second terminal as a forward direction, and
the fourth semiconductor element includes a diode that uses a direction from the second node to the second terminal as a forward direction.

12. The power converter according to claim 1, wherein
the first semiconductor element includes a diode that uses a direction from the reference voltage node to the first node as a forward direction,
the second semiconductor element includes a diode that uses a direction from the reference voltage node to the second node as a forward direction,
the third semiconductor element includes the first switching element, and
the fourth semiconductor element includes the second switching element.

13. The power converter according to claim 1, wherein
the first semiconductor element includes the first switching element,
the second semiconductor element includes the second switching element,
the third semiconductor element includes a switching element that is turned on and off complementarily to the first switching element, and
the fourth semiconductor element includes a switching element that is turned on and off complementarily to the second switching element.

14. The power converter according to claim 1, comprising the N DC voltage conversion circuits (N: an integer that is 2 or more), wherein
the N DC voltage conversion circuits are connected in parallel between the first and second terminals, and
the control unit performs control to turn on and off the first and second switching elements of the respective DC voltage conversion circuits to provide ON timings of the first switching elements and ON timings of the second switching elements with phase differences between the N DC voltage conversion circuits.

15. The power converter according to claim 14, wherein (2·N) switching elements corresponding to a whole of the first and second switching elements of the N DC voltage conversion circuits are subjected to ON/OFF control in accordance with common switching cycle length and respective phase differences are provided between turn-on timings of the (2·N) switching elements, the phase differences each corresponding to 1/(2·N) times the switching cycle length.
